(19) United States
(12) Patent Application Publication
(10) Pub. No.: US 2020/0266431 A1
(43) Pub. Date: Aug. 20, 2020

(54) ANODE MATERIAL, AND ELECTROCHEMICAL DEVICE AND ELECTRONIC DEVICE COMPRISING THE SAME

(71) Applicant: NINGDE AMPEREX TECHNOLOGY LIMITED, Ningde City (CN)

(72) Inventors: Chengbo ZHANG, Ningde City (CN); Hang CUI, Ningde City (CN); Yuansen XIE, Ningde City (CN)

(73) Assignee: NINGDE AMPEREX TECHNOLOGY LIMITED

(21) Appl. No.: 16/458,973

(22) Filed: Jul. 1, 2019

(30) Foreign Application Priority Data
Feb. 20, 2019 (CN) 201910126284.1

(51) Int. Cl. H01M 4/485; H01M 10/0525

(52) U.S. Cl. CPC H01M 4/485; H01M 2004/027; H01M 10/0525

(57) ABSTRACT

The present application relates to an anode material, and an electrochemical device and an electronic device comprising the same. The anode material is a silicon-based anode material having a core-shell structure, where a core is silicon oxide, and the silicon oxide can be represented by the general formula SiOₓ (about 0<x<about 2); and where the shell disposed on at least a portion of an outer surface of the silicon oxide core comprises a silicate of element M, and M is selected from the group consisting of Mg, Ca, Sr, Ba, Al, Ti, Zn and a combination thereof. The lithium-ion battery prepared from the anode material has high first coulombic efficiency and excellent cycle performance.

### CROSS REFERENCE TO RELATED APPLICATIONS

The present application claims the benefit of priority from the China Patent Application No. 201910126284.1, filed on 20 Feb. 2019, the disclosure of which is hereby incorporated by reference in its entirety.

### BACKGROUND

### 1. Technical Field

The present application relates to the field of energy storage, and more particularly to an anode material and an electrochemical device comprising the same.

### 2. Description of the Related Art

With the popularity of consumer electronics products such as notebook computers, mobile phones, handheld game consoles, tablet computers, mobile power supplies and drones, the requirements for electrochemical devices (for example, batteries) have become ever more stringent. For example, people require not only light weight, but also high capacity and long service life of the batteries. Among the numerous types of batteries there are on the market, lithium-ion batteries have come to occupy a leading position in the market due to their outstanding advantages, such as high energy density, notable safety, low self-discharge, no memory effect, and long service life.

### SUMMARY

The present application provides an anode material, an anode comprising the anode material, an electrochemical device and an electronic device using the anode, and a method for preparing the anode material to try to solve at least one of the problems that exist in the relevant field to at least some extent.

In an embodiment, the present application provides an anode material, comprising: a silicon oxide core, the silicon oxide being represented by the general formula SiOₓ (about 0<x<about 2); and a shell, disposed on at least a portion of an outer surface of the silicon oxide core, where the shell comprises a silicate of M, and where M is selected from the group consisting of Mg, Ca, Sr, Ba, Al, Ti, Zn and a combination thereof.

In some embodiments, the molar ratio of the M to the Si in the anode material is about 0.1 to about 0.6.

In some embodiments, the thickness L of the shell is about L≤3.0 μm.

In some embodiments, the content of the element M is gradually decreased from the outside of the shell to the inside of the shell.

In some embodiments, the anode material comprises silicon grains, where the size D of the silicon grains is about 2 nm≤D≤about 40 nm, and where the size D is determined by the Scherrer equation based on the half-peak width of the diffraction peak of Si(111) in an X-ray diffraction analysis.

In another embodiment, the present application provides an anode, comprising an anode current collector and an anode active material layer, where the anode active material layer is located on at least one surface of the current collector, and where the anode active material layer comprises the anode material according to the above embodiments.

In another embodiment, the present application provides an electrochemical device, comprising a cathode, a separator, an electrolyte and the anode according to the above embodiments.

In some embodiments, the electrochemical device is a lithium-ion battery.

In another embodiment, the present application provides an electronic device, comprising the electrochemical device according to the above embodiments.

In another embodiment, the present application provides a method for preparing the anode material in the above embodiments, comprising: mixing an M source and a silicon oxide; carrying out a high-temperature treatment on the mixed material in an inert gas atmosphere at about 1000° C. to about 1400° C.; and grinding the material subjected to the high-temperature treatment.

Additional aspects and advantages of the embodiments of the present application will be described or shown in the following description or interpreted by implementing the embodiments of the present application.

### BRIEF DESCRIPTION OF THE DRAWINGS

The following will briefly illustrate the accompanying drawings necessary to describe the embodiments of the present application or the existing technology so as to facilitate the description of the embodiments of the present application. Obviously, the accompanying drawings described below are only part of the embodiments of the present application. For those skilled in the art, the accompanying drawings of other embodiments can still be obtained according to the structures illustrated in the accompanying drawings without any creative effort.

FIG. 1 is a schematic view of an anode material according to some embodiments of the present application;

FIG. 2 is an X-ray diffraction (XRD) pattern of the sample obtained in Embodiment 1 of the present application;

FIG. 3 shows a cross-sectional scanning electron microscope (SEM) image and element distribution diagrams of elements O, Mg and Si of the sample obtained in Embodiment 1 of the present application;

FIG. 4 shows linear scan element distribution diagrams of the sample obtained in Embodiment 1 of the present application;

FIG. 5 is a cross-sectional SEM image of the sample obtained in Embodiment 1 of the present application at a higher magnification;

FIG. 6 is a photograph showing the state of existence of the sample obtained in Embodiment 1 of the present application in water;

FIG. 7 is a first charge and discharge curve of the sample obtained in Embodiment 1 of the present application;

FIG. 8 is a comparison chart of the cycle performance of the samples obtained in Embodiment 1 and Comparative Example 1 of the present application; and

FIG. 9 is an XRD pattern of the sample obtained in Embodiment 5 of the present application.

### DETAILED DESCRIPTION

Embodiments of the present application are described in detail below. Throughout the specification, the same or similar components and components having the same or similar functions are denoted by similar reference numerals. The embodiments described herein with respect to the accompanying drawings are illustrative and graphical, and are used for providing a basic understanding on the present application. The embodiments of the present application should not be construed as limiting the present application.

As used herein, the terms “substantially”, “generally”, “essentially” and “about” are used to describe and explain small variations. When being used in combination with an event or circumstance, the term may refer to an example in which the event or circumstance occurs precisely, and an example in which the event or circumstance occurs approximately. For example, when used in conjunction with a numerical value, the terms may refer to a variation range that is less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if the difference between two values is less than or equal to ±10% of the average of the values (e.g., less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), the two values can be considered “substantially” the same.

In addition, amounts, ratios and other numerical values are sometimes presented herein in a range format. It should be appreciated that such range formats are for convenience and conciseness, and should be flexibly understood as comprising not only values explicitly specified to range constraints, but also all individual values or sub-ranges within the ranges, like explicitly specifying each value and each sub-range.

In specific embodiments and claims, a list of items connected by the terms “one of” or other similar terms may mean any one of the listed items. For example, if items A and B are listed, then the phrase “one of A and B” means only A or only B. In another example, if items A, Band C are listed, then the phrase “one of A, B and C” means only A; only B; or only C. The item A may include a single element or multiple elements. The item B may include a single element or multiple elements. The item C may include a single element or multiple elements.

In specific embodiments and claims, a list of items connected by the terms “at least one of” or other similar terms may mean any combinations of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single element or multiple elements. The item B may include a single element or multiple elements. The item C may include a single element or multiple elements.

In the present application, the term “silicon oxide” refers to a substance which can be represented by the general formula SiOₓ (0<x<2). For example, the silicon oxide refers to nano silicon grains dispersed in a base of silicon oxide, and the “silicon oxide” here comprises, but is not limited to, silicon dioxide.

### I. Anode Material

The anode material is one of the most critical components in lithium-ion batteries, and its structure and properties directly affect the electrochemical performance of lithium-ion batteries. Since graphite has the advantages of low cost, wide source, and suitability for commercialization, graphite is dominant in the commercial anode materials for lithium-ion batteries. However, the theoretical capacity of the graphite is only 372 mAh/g, and the actual capacity is even lower, which limits the application of graphite in the fields requiring a high energy output.

Owing to the advantages of high theoretical capacity, low lithium intercalation potential, high electrochemical reversible capacity, good safety performance and abundant resources, the silicon-based anode material has become a research hotspot of a new generation of lithium-ion battery anode materials. Silicon and silicon oxide are representative materials among them.

When silicon is used as the anode material, its theoretical capacity is 4200 (mAh/g), which is at least ten times higher than the theoretical capacity of graphite. However, in the process of intercalation of lithium ions, the volume of silicon can be expanded to a volume of 300% or more. At the same time, when lithium ions are deintercalated, the volume of silicon undergoes a sharp contraction. The rapid expansion and contraction cause pulverization and shedding of the anode active material, resulting in a severe capacity degradation, thereby deteriorating the cycle performance of the battery.

When the silicon oxide is used as the anode material, its capacity is only half of the capacity of the silicon anode active material, but its volume change during charge and discharge is small, and it has a good cycle performance compared to the silicon anode active material. However, during the first charge process, the silicon oxide reacts irreversibly with lithium to form lithium silicide and lithium oxide, and the lithium oxide cannot participate in subsequent electrochemical reactions. It results in irreversible consumption of a portion of the lithium ions during the first charge process, and this portion of the lithium ions cannot be deintercalated during the discharge process to return to the cathode. Therefore, the first coulombic efficiency of the silicon oxide anode material is low.

In view of the above technical problems, the industry has tried various solutions. For example, the patent application CN102214823A proposes to dope lithium into the bulk of silicon oxide to increase the first coulombic efficiency. However, the lithium-doped silicon oxide anode material has a poor stability in water, which makes it difficult to maintain the stability of the anode active material during the slurry preparation for preparing the battery, thereby affecting the performance of the battery. In addition, lithium resources are limited and costly, and the technical solution of the above patent application is not conducive to industrial production.

For another example, the patent application CN106537659A proposes doping magnesium gas into the bulk of silicon oxide to increase the first coulombic efficiency. However, this method has higher requirements on equipment and consumes a large amount of energy, making it difficult to achieve a mass production. Moreover, this method is difficult to achieve a uniform doping, which is easy to cause pore structures inside the particles and affects the cycle stability of the material.

At least for the above technical problems and for the defects existing in the prior art, the present application provides a silicon-based anode material having a core-shell structure. The core of the silicon-based anode material is silicon oxide, and the silicon oxide can be represented by the general formula SiOₓ (0<x<2). The shell of the silicon-based anode material comprises a silicate of M, where M is selected from the group consisting of Mg, Ca, Sr, Ba, Al, Ti, Zn and a combination thereof. The shell is disposed on at least a portion of an outer surface of the core.

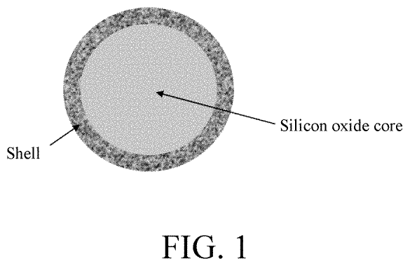

In order to more intuitively demonstrate the core-shell structure provided by the present application, FIG. 1 shows a schematic diagram of an anode material according to some embodiments of the present application. As shown in FIG. 1, a layer of outer shell is formed on the outer surface of the silicon oxide core to “protect” the silicon oxide core. The core-shell structure has the following advantages:

1. The components in the outer shell cannot irreversibly react with the lithium ions in the electrolyte, and the irreversible consumption of lithium ions by the silicon oxide in the core is prevented, so that the first coulombic efficiency of the anode material is enhanced;

2. In the process of lithium intercalation and deintercalation, since the shell cannot intercalate or deintercalate lithium ions, the outer shell cannot undergo a volume expansion or contraction to form a “rigid” outer shell; the “rigid” outer shell can protect the silicon oxide core from rupture which may occur during the repeated expansion and contraction, and can reduce side reactions between the surface of the silicon oxide core and the electrolyte, thereby improving the cycle performance of the anode material;

3. The inside of the anode material is a dense structure of silicon oxide without any doping, which reduces the risk of generating a pore defect structure inside the particles, thereby improving the cycle performance of the anode material;

4. Since the shell is insoluble in water, the anode material described in the present application can be stably present in the aqueous slurry preparation process.

It should be understood that FIG. 1 is only a schematic diagram of the core-shell structure taught by the present application. In this schematic diagram, the outer shell completely covers the outer surface of the silicon oxide core. However, “complete coverage” is not necessary to realize the technical solution of the present application. The technical idea of the present application can be realized as long as the outer shell covers at least a portion of the outer surface of the core. In addition, the shape of the silicon oxide core of the present application is not limited to the circular shape shown in FIG. 1, and the silicon oxide core of the present application can be in various shapes according to actual process conditions, for example, but not limited to, an elliptical shape, an irregular spherical shape, and any irregular shape.

In some embodiments of the present application, the silicon oxide can be represented by the general formula SiOₓ, where the range of x is about 0<x<about 2. In some embodiments, the range of x is about 0.5<x<about 1.6. In some embodiments, the range of x is about 0.6<x<about 0.9.

In some embodiments of the present application, the molar ratio of the element M to Si in the anode material is about 0.1 to about 0.6. In some embodiments, the molar ratio of the element M to Si in the anode material is about 0.2 to about 0.4. As the content of the element M in the anode material increases, the molar ratio of the element M to Si also increases, and meanwhile, the coverage area of the shell or the thickness of the shell gradually increases. Therefore, appropriately increasing the molar ratio of the element M to Si in the anode material can achieve more effective protection on the silicon oxide core, so as to increase the first coulombic efficiency of the anode material and improve the cycle stability of the anode material. However, since the outer shell is not electrochemically active, when the content of the element M is too high, the capacity per gram of the anode material will be lowered.

In some embodiments of the present application, the thickness L of the shell is about L≤3.0 μm. In some embodiments, the thickness L of the shell is about 0.1 μm≤L≤about 2.5 μm. In some embodiments, the thickness L of the shell is about 0.4 μm≤L≤about 2 μm. Appropriate shell thickness can achieve a more effective protection on the silicon oxide core, so as to increase the first coulombic efficiency of the anode material and improve the cycle stability of the anode material. However, an excessively thick shell may sacrifice the capacity per gram of the anode material and reduce the energy density of the lithium-ion battery.

In some embodiments of the present application, the content of the element M gradually decreases from the outside of the shell to the inside of the shell.

In some embodiments of the present application, the anode material further comprises silicon grains, and the size D of the silicon grains is about 2 nm≤D≤about 40 nm, where the size D is determined by the following Scherrer equation based on the half-peak width (FWHM) of the diffraction peak of Si(111) in an X-ray diffraction analysis:

C·S[nm]=K·λ/B·cos θ,

In the above equation, K=0.9, λ=0.154 nm, B=full width at half maximum (FWHM, rad), and θ=peak position (angle).

The silicon grains in the anode material being oversize or undersize will affect the electrochemical performance of the anode material. For example, when the size of the silicon grains is too large, the volume of the anode material excessively expands and contracts during the intercalation and deintercalation of lithium ions, which may cause breakage of the particles of the anode material. When the size of the silicon crystal grains is too small, due to the large specific surface area, there may be more side reactions during the intercalation and deintercalation of lithium ions, resulting in deterioration of the cycle performance of the anode material.

### II. Preparation Method of Anode Material

The embodiments of the present application also provide a method for preparing an anode material. Specifically, the present application adopts the following method steps to prepare the above anode material:

Step 1: mixing an M source and a silicon oxide SiO_{y} (about 0<y<about 2).

Step 2: carrying out a high-temperature treatment on the mixed material in an inert gas atmosphere at about 1000 to about 1400° C.′

Step 3: grinding the material subjected to the high-temperature treatment.

When the M source and the silicon oxide SiO_{y} are mixed, the M source is coated on the surface of the silicon oxide SiO_{y}. During the subsequent high-temperature treatment, the M source reacts with the surface material of the silicon oxide SiO_{y} to form a silicate containing M, thereby forming an outer shell to protect the silicon oxide core.

In some embodiments of the present application, the M source is an oxide, salt or base of M. For example, when the element M is magnesium, the magnesium source can be magnesium oxide, and may also be, but not limited to, magnesium chloride, magnesium acetate, magnesium sulfate, magnesium hydroxide, magnesium carbonate, or the like.

In some embodiments of the present application, the mixing can be performed using, but not limited to, any one of a V-type mixer, a three-dimensional mixer, a gas flow mixer and a horizontal mixer.

In some embodiments, the inert gas can be, but is not limited to, at least one of helium, argon and nitrogen.

In some embodiments, the mixed material is subjected to a high-temperature treatment in an inert gas atmosphere at about 1000 to about 1350° C. In some embodiments, the mixed material is subjected to a high-temperature treatment in an inert gas atmosphere at about 1050 to about 1300° C. In some embodiments, the mixed material is subjected to a high-temperature treatment in an inert gas atmosphere at about 1100 to about 1300° C. In some embodiments, the mixed material is subjected to a high-temperature treatment in an inert gas atmosphere at about 1100° C., about 1200° C., or at about 1300° C.

In some embodiments, the high-temperature treatment may use, but not limited to, any one of a tube furnace, a box furnace and a rotary kiln for high temperature heating.

The preparing method provided by the embodiments of the present application has the following characteristics and advantages:

Firstly, the preparation method is simple and easy to operate, controllable in reaction conditions and highly suitable for industrial production, and has broad commercial application prospects.

Secondly, the above coating process is an in-situ reaction occurring on the silicon oxide base, and the formed coating layer is closely associated with the base, and is not easily separated from the base, such that the coating layer can “reliably” protect the base, so as to increase the first coulombic efficiency of the anode material and improve the cycle stability of the anode material.

### III. Anode

The embodiments of the present application further provide an anode, comprising an anode active material layer and a current collector, where the anode active material layer is located on at least one surface of the current collector, and where the anode active material layer comprises the anode material of the present application. In some embodiments of the present application, the current collector can be, but not limited to, copper foil or nickel foil.

In some embodiments of the present application, the anode active material layer further comprises a binder and a conductive agent. The binder is mainly used to “firmly” bond the anode material together to form an active system that is closely associated and interconnected. The conductive agent is mainly used to enhance the conductivity of the anode active material layer and accelerate the transport of electrons in the anode active material layer. In some embodiments, the binder can be at least one of polyvinylidene fluoride, a vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polymethyl methacrylate, polytetrafluoroethylene and polyhexafluoropropylene, styrene-butadiene rubber, acrylate ester and epoxy resin. In some embodiments, the conductive agent can be at least one of conductive carbon black, carbon fibers, Ketjen black, acetylene black, carbon nanotubes and graphene.

In some embodiments of the present application, the anode further comprises an undercoat layer between the anode active material layer and the current collector. In some embodiments, the undercoat layer comprises at least one of conductive carbon black, carbon fibers, Ketjen black, acetylene black, carbon nanotubes and graphene.

The undercoat layer is mainly used to conduct and bond, and the appropriate thickness of the undercoat layer can promote the optimum kinetic effects of the anode active material. In some embodiments of the present application, the thickness ratio of the undercoat layer to the anode active material layer is about (1:10) to about (1:200). In some embodiments, the thickness ratio of the undercoat layer to the anode active material layer is about (1:20) to about (1:150).

The compaction density of the electrode also affects the electrochemical performance of the electrode. For example, if the compaction density is too high, the porosity in the electrode is remarkably reduced, and the infiltration effect of the electrolyte is deteriorated, resulting in the diffusion passage of lithium ions being blocked; and if the compaction density is too low, the contact between the active materials becomes reduced, resulting in the transport passage of electrons being blocked. In some embodiments of the present application, the compaction density of the anode is about 1.00 to about 2.00 g/cc. In some embodiments, the compaction density of the anode is about 1.30 to about 1.70 g/cc.

### IV. Electrochemical Device

The embodiments of the present application also provide an electrochemical device using the anode material of the present application. In some embodiments, the electrochemical device comprises a cathode containing a cathode material, an anode containing the anode material of the present application, a separator and an electrolyte.

In some embodiments of the present application, the electrochemical device is a lithium-ion battery. In the lithium-ion battery, the cathode active material layer comprises a cathode material capable of absorbing and releasing lithium (Li) (hereinafter, sometimes referred to as “a cathode material capable of absorbing/releasing lithium Li”) and a cathode current collector. In some embodiments of the present application, the cathode current collector of the cathode can be, but not limited to, aluminum foil or nickel foil. Examples of the cathode material capable of absorbing/releasing lithium (Li) may include one or more of lithium cobalt oxide, lithium nickel cobalt manganese oxide, lithium nickel cobalt aluminum oxide, lithium manganese oxide, lithium manganese iron phosphate, lithium vanadium phosphate, oxylithium vanadium phosphate, lithium iron phosphate, lithium titanate and lithium-rich manganese-based material.

In the above cathode material, the chemical formula of lithium cobalt oxide can be LiₓCoₐM1_{b}O_{2-c}, where M1 is selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), silicon (Si) and a combination thereof, and the values of x, a, b and c are respectively in the following ranges: 0.8≤x≤1.2, 0.8≤a≤1, 0≤b≤0.2 and −0.1≤c≤0.2;

In the above cathode material, the chemical formula of the lithium nickel cobalt manganese oxide or lithium nickel cobalt aluminum oxide can be Li_{y}Ni_{d}M2ₑO_{2-f}, where M2 is selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr), silicon (Si) and a combination thereof, the values of y, d, e and f are respectively in the following ranges: 0.8≤y≤1.2, 0.3≤d≤0.98, 0.02≤e≤0.7 and −0.1≤f≤0.2;

In the above cathode material, the chemical formula of lithium manganese oxide is Li_{z}Mn_{2-g}M3_{g}O₄₋ₕ, where M3 is selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W) and a combination thereof, and the values of z, g and h are respectively in the following ranges: 0.8≤z≤1.2, 0≤g<1.0 and −0.2≤h≤0.2.

The above lithium-ion battery further comprises an electrolyte, and the state of the electrolyte can be a gel state, a solid state or a liquid state. The liquid electrolyte commonly used comprises a lithium salt and a non-aqueous solvent.

The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB and lithium difluoroborate. For example, LiPF₆ is selected as the lithium salt because it can provide high ionic conductivity and improve cycle performance.

The non-aqueous solvent can be a carbonate compound, a carboxylate compound, an ether compound, other organic solvent or a combination thereof.

The carbonate compound can be a chain carbonate compound, a cyclic carbonate compound, a fluorocarbonate compound or a combination thereof.

Examples of the chain carbonate compound are diethyl carbonate (DEC), dimethyl carbonate (DMC), dipropyl carbonate (DPC), methylpropyl carbonate (MPC), ethylpropyl carbonate (EPC), methylethyl carbonate (MEC) and a combination thereof. Examples of the cyclic carbonate compound are ethylene carbonate (EC), propylene carbonate (PC), butylene carbonate (BC), vinyl ethylene carbonate (VEC), propyl propionate (PP), and a combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate and a combination thereof.

Examples of the carboxylate compound are methyl acetate, ethyl acetate, n-propyl acetate, t-butyl acetate, methyl propionate, ethyl propionate, γ-butyrolactone, azlactone, valerolactone, mevalonolactone, caprolactone, methyl formate and a combination thereof.

Examples of the ether compound are dibutyl ether, tetraethylene glycol dimethyl ether, diglyme, 1,2-dimethoxyethane, 1,2-diethoxyethane, ethoxy methoxyethane, 2-methyltetrahydrofuran, tetrahydrofuran and a combination thereof.

Examples of other organic solvents are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate and a combination thereof.

According to the embodiments of the present application, the lithium-ion battery further comprises a separator, and when the lithium ions in the electrolyte are allowed to pass through the separator in the lithium-ion battery, the separator in the lithium-ion battery avoids a direct physical contact between the anode and the cathode and prevents the occurrence of a short circuit. The separator is typically made of a material which is chemically stable and inert when being in contact with the electrolyte and the electrode. At the same time, the separator needs to have mechanical robustness to withstand the stretching and piercing of the electrode material, and the pore size of the separator is typically less than 1 micron. Various separators comprising microporous polymer membranes, non-woven mats and inorganic membranes have been used in the lithium-ion batteries, where the polymer membranes based on microporous polyolefin materials are the most commonly used separators in combination with the liquid electrolyte. The microporous polymer membranes can be made very thin (typically about 25 μm) and highly porous (typically 40%) to reduce electrical resistance and increase ion conductivity. Meanwhile, the polymer membrane still has mechanical robustness. Those skilled in the art will appreciate that various separators widely used in lithium-ion batteries are suitable for use in the present application.

Although the foregoing illustrates by taking the lithium-ion battery as an example, after reading the present application, those skilled in the art can conceive that the anode material of the present application can be used for other suitable electrochemical devices. Such electrochemical devices include any device for generating an electrochemical reaction, and specific examples thereof include all kinds of primary batteries, secondary batteries, fuel cells, solar cells or capacitors. In particular, the electrochemical device is a lithium secondary battery, comprising a lithium metal secondary battery, a lithium ion secondary battery, a lithium polymer secondary battery, or a lithium ion polymer secondary battery.

### V. Application

The electrochemical device manufactured from the anode material according to the present application is suitable for the electronic devices in various fields.

The use of the electrochemical device of the present application is not particularly limited and can be used for any use known in the art. In one embodiment, the electrochemical device of the present application can be used for, but not limited to, notebook computers, pen input computers, mobile computers, e-book players, portable telephones, portable fax machines, portable copy machines, portable printers, stereo headphones, VCRs, LCD TVs, portable cleaners, portable CD players, mini disc players, transceivers, electronic notebooks, calculators, memory cards, portable recorders, radios, backup power devices, motors, cars, motorcycles, power bicycles, bicycles, lighting fixtures, toys, game consoles, clocks, power tools, flashlights, cameras, large household batteries, lithium ion capacitors, etc.

Below the lithium-ion battery is taken as an example for illustrating the benefits and advantages brought by the present application by combining with specific embodiments of preparing the anode material of the present application and testing methods for the electrochemical device. However, those skilled in the art will appreciate that the preparing methods described in the present application are merely examples, and that any other suitable preparing method is within the scope of the present application.

### VI. Embodiments

Preparation of Lithium-Ion Battery

The anode materials in the embodiments and comparative examples were prepared into lithium-ion batteries by the following preparing method. Specifically, the anode material prepared in the following embodiments and comparative examples, the conductive agent acetylene black and the binder polyacrylic acid resin (PAA) were sufficiently stirred and uniformly mixed according to a weight ratio of 80:10:10 in deionized water to prepare an anode slurry, and the anode slurry was uniformly coated on the front and back surfaces of the anode current collector copper foil and dried at about 85° C. to form an anode active material layer, and then cold pressing, slitting, slice cutting and welding of the anode tab were carried out to obtain an anode.

The cathode material lithium cobalt oxide (molecular formula LiCoO₂), a conductive agent acetylene black and a binder polyvinylidene fluoride (PVDF) were sufficiently stirred and uniformly mixed according to a weight ratio of 96:2:2 in N-methylpyrrolidone to form a cathode slurry, then the obtained cathode slurry was uniformly coated on the front and back surfaces of a cathode current collector aluminum foil and dried at about 85° C., and cold pressing, slitting, slice cutting and welding of the cathode tab were carried out to obtain a cathode.

A solution prepared from a lithium salt LiPF₆ and a non-aqueous organic solvent (ethylene carbonate (EC):diethyl carbonate (DEC):propylene carbonate (PC):propyl propionate (PP):vinylene carbonate (VC)=20:30:20:28:2, mass ratio) according to a mass ratio of 8:92 was used as an electrolyte of the lithium-ion battery.

A ceramic-coated polyethylene (PE) material separator was used as the separator.

The cathode, the separator and the anode were stacked in order, so that the separator was between the cathode and anode to play a role in separation. The electrode assembly was placed in a package, the electrolyte was injected, packaging was performed, and then formation was performed to prepare the final lithium-ion battery.

Tests of Lithium-Ion Battery

The prepared lithium-ion battery was tested as follows, and the test conditions were as follows:

(1) Charge and Discharge Test

The battery was discharged at a constant rate of 0.05 C to 5 mV, and then discharged at a constant voltage of 5 mV until the current dropped to 10 uA; and then the battery was charged at a constant current of 0.05 C to 2 V to complete the charge and discharge capacity test.

(2) Cycling Performance Test

The battery was discharged at a constant rate of 0.05 C to 5 mV, and then discharged at a constant voltage of 5 mV until the current dropped to 10 uA; and then the battery was charged at a constant current of 0.05 C to 2 V to complete a charge and discharge cycle. The above charge and discharge cycle test is repeated to test the cycling performance of the lithium-ion battery.

### DETAILED DESCRIPTION

Specific embodiments of the anode material provided by the present application will be described in detail below.

### (1) Embodiments 1-4 and Comparative Example 1

### Comparative Example 1

SiO_{y} (y is 0.8) was subjected to a heat treatment in a nitrogen gas atmosphere at 1100° C. for 2 hours. The average particle diameter D₅₀ of the SiO_{y} (y is 0.8) was 6 μm.

### Embodiment 1

Magnesium oxide and silicon oxide SiO_{y} (y is 0.8) were thoroughly mixed according to a mass ratio of 2:8, and the mixed material was subjected to a heat treatment in a nitrogen atmosphere at 1100° C. for 2 hours. The sample subjected to the heat treatment was ground and further sieved to obtain the sample described in Embodiment 1.

### Embodiments 2-4

The difference between Embodiments 2-4 and Embodiment 1 was only that the mass ratio of magnesium oxide to silicon oxide SiO_{y} (y is 0.8) was adjusted to 1:9, 3:7 and 4:6, respectively, and other treatment processes and parameters were the same as in Embodiment 1.

Taking the sample obtained in Embodiment 1 of the present application as an example, the present application performed tests as follows.

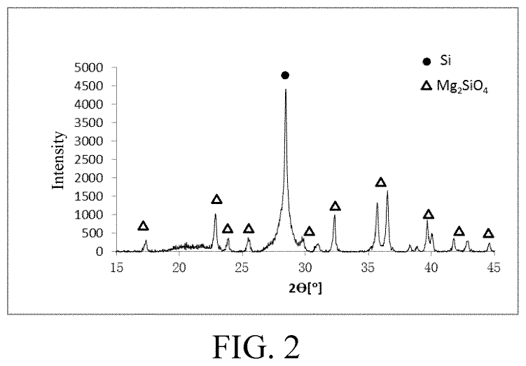

FIG. 2 is an X-ray diffraction pattern of the sample obtained in Embodiment 1 of the present application. FIG. 2 shows the appearance of a crystal cell at 2θ being around 21° and a strong peak of Si (Si<111>) at 2θ being around 28°, which is the characteristic peak of silicon oxide SiOₓ (x is 0.7). FIG. 2 also shows a plurality of characteristic peaks of Mg₂SiO₄, demonstrating the presence of Mg₂SiO₄. This shows that the sample obtained in Embodiment 1 is a SiOₓ.Mg₂SiO₄ composite. Further, the grain size of Si in the sample of Embodiment 1 can be calculated based on the half-peak width of the diffraction peak of Si<111>.

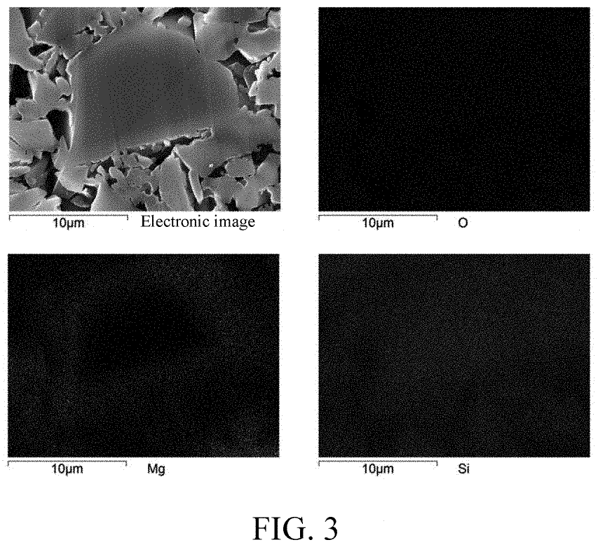

The upper left corner of FIG. 3 is a cross-sectional SEM image of the sample obtained in Embodiment 1 of the present application. As can be seen from FIG. 3, the sample of Embodiment 1 has a core-shell structure (for example, the drawing shows the core in a darker color and the shell in a lighter color). It can be seen from the distribution diagram of the Mg element of FIG. 3 (the image on the lower left corner) that the Mg element is mainly distributed at the edges (shells) of the sample particles, which also indicates that the magnesium silicate is distributed in the shell of the sample of Embodiment 1.

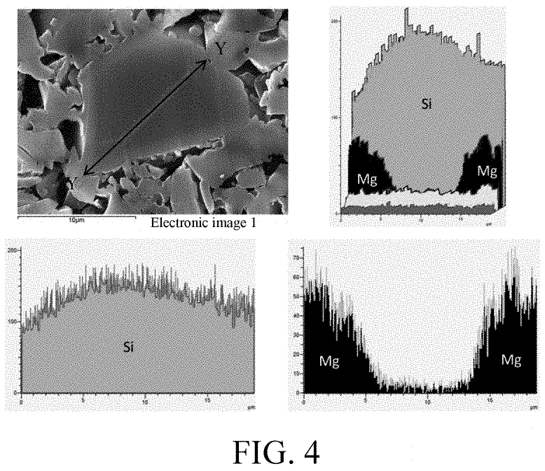

FIG. 4 shows linear scan element distribution diagrams of the sample shown in FIG. 3 along the line Y-Y. As can be seen from FIG. 4, the content of the Mg element gradually decreases from the outside of the shell of the sample to the inside of the shell.

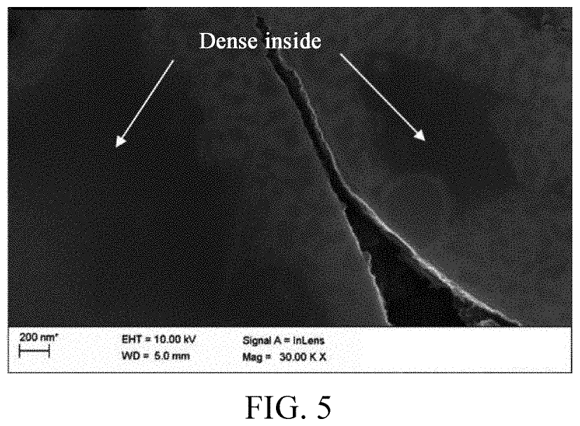

FIG. 5 is a cross-sectional SEM image of the sample obtained in Embodiment 1 of the present application at a higher magnification. As can be seen from FIG. 5, the core portion of the sample is dense.

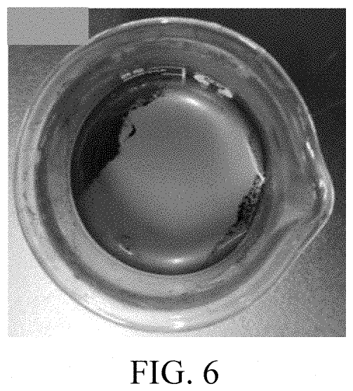

FIG. 6 shows the state of the sample obtained in Embodiment 1 of the present application in water. As shown in FIG. 6, the anode material of the present application can be stably present in water without gas generation.

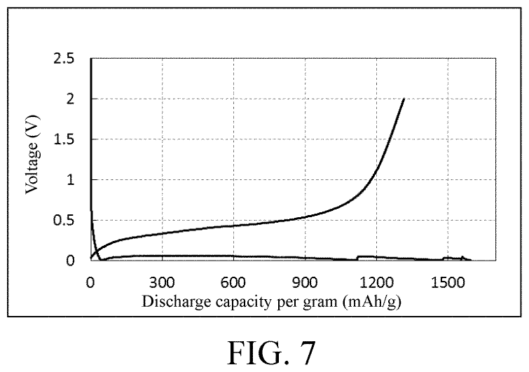

FIG. 7 is a first charge and discharge curve of the sample obtained in Embodiment 1. From the charge and discharge curve, the first charge capacity per gram, the first discharge capacity per gram and the first coulombic efficiency of the sample of Embodiment 1 can be calculated.

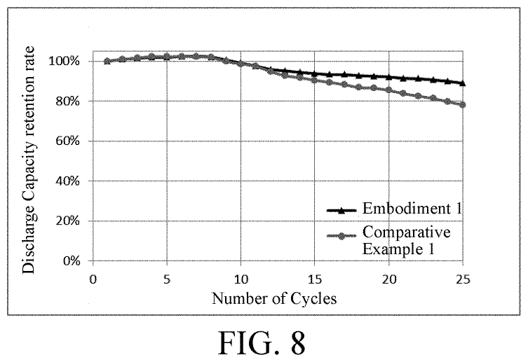

FIG. 8 is a comparison chart of the cycle performance of the samples obtained in Embodiment 1 and Comparative Example 1. As shown in FIG. 8, the anode material of Embodiment 1 has a better cycle stability than the anode material of Comparative Example 1.

The implementation variables, and the characteristic parameters and the electrochemical data of the obtained samples of Embodiments 1-4 and Comparative Example 1 are shown in Table 1:

TABLE 1

| | | Mg/Si | | Si<111> | | Capacity | First |
|---|---|---|---|---|---|---|---|
| | MgO/SiO_{y} | Molar | Shell | Half-peak | Si Grain | Per Gram | Coulombic |
| Sample | Mass Ratio | Ratio | Thickness | Width [2θ] | Size (nm) | (mAh/g) | Efficiency |
| Embodiment 1 | 2:8 | 0.22 | ≤1.2 um | 0.482 | 16.8 | 1316 | 82.6% |
| Embodiment 2 | 1:9 | 0.12 | ≤0.4 um | 0.634 | 12.8 | 1385 | 81.9% |
| Embodiment 3 | 3:7 | 0.30 | ≤1.5 um | 0.401 | 20.2 | 1132 | 83.5% |
| Embodiment 4 | 4:6 | 0.51 | ≤2.0 um | 0.336 | 24.1 | 989 | 84.6% |
| Comparative | 0:1 | 0 | 0 | 0.774 | 10.5 | 1490 | 79.0% |
| Example 1 | | | | | | | |

Comparing Embodiments 1-4 with Comparative Example 1, it can be known that the formation of a shell on the surface layer of the silicon oxide base can improve the first coulombic efficiency of the silicon oxide. Comparing Embodiments 1-4, as the Mg/Si molar ratio gradually increases, the thickness of the magnesium silicate shell also gradually increases, and the first coulombic efficiency of the anode material gradually increases. However, as the Mg/Si molar ratio gradually increases, the capacity per gram of the anode material gradually decreases.

### (2) Embodiments 5-7

The difference between Embodiments 5-7 and Embodiment 1 was only that the temperature of the high-temperature treatment was adjusted to 1000° C., 1200° C. and 1300° C. respectively, and other treatment processes and parameters were the same as in Embodiment 1.

The implementation variables, and the characteristic parameters and the electrochemical data of the obtained samples of Embodiments 1 and 5-7 are shown in Table 2:

TABLE 2

| | Reaction | | | Si<111> | | Capacity | First |
|---|---|---|---|---|---|---|---|
| | Temperature | Reaction | Shell | Half-peak | Si Grain | Per Gram | Coulombic |
| Sample | (° C.) | Time | Thickness | Width [2θ] | Size (nm) | (mAh/g) | Efficiency |
| Embodiment 1 | 1100 | 2 | ≤1.2 um | 0.482 | 16.8 | 1316 | 82.6% |
| Embodiment 5 | 1000 | 2 | ≤0.1 um | 2.25 | 3.6 | 1375 | 79.4% |
| Embodiment 6 | 1200 | 2 | ≤1.2 um | 0.316 | 25.7 | 1273 | 81.2% |
| Embodiment 7 | 1300 | 2 | ≤1.2 um | 0.207 | 39.2 | 1260 | 80.9% |

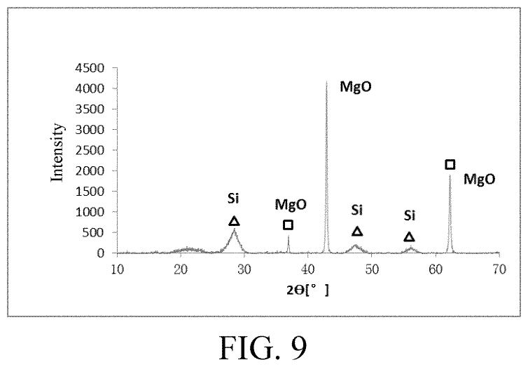

It can be seen from the data in Table 2, as the reaction temperature increases, the first coulombic efficiency of the anode material tends to increase gradually. When the high-temperature treatment temperature is 1000° C., the degree of improvement of the first coulombic efficiency is small. This is mainly because: first, the treatment temperature is too low, magnesium oxide and silicon oxide cannot be fully reacted to form a magnesium silicate shell, and magnesium is mainly present in the shell of the anode material in the form of magnesium oxide (see FIG. 9); and second, the thickness of the shell is too small to effectively prevent side reactions between silicon oxide and lithium ions during the first charge and discharge process. When the high-temperature treatment temperature is too high, the improvement of the first coulombic efficiency is no longer obvious. This is because the excessive temperature will result in a larger Si grain size.

### (3) Embodiments 8 and 9

The difference between Embodiments 8 and 9 and Embodiment 1 was only that the high-temperature treatment time was adjusted to 1 hour and 12 hours respectively, and the other treatment processes and parameters were the same as in Embodiment 1.

The implementation variables, and the characteristic parameters and the electrochemical data of the obtained samples of Embodiments 1, 8 and 9 are shown in Table 3:

TABLE 3

| | Reaction | | | Si<111> | | Capacity | First |
|---|---|---|---|---|---|---|---|
| | Temperature | Reaction | Shell | Half-peak | Si Grain | Per Gram | Coulombic |
| Sample | (° C.) | Time | Thickness | Width [2θ] | Size (nm) | (mAh/g) | Efficiency |
| Embodiment 1 | 1100 | 2 | ≤1.2 um | 0.482 | 16.8 | 1316 | 82.6% |
| Embodiment 8 | 1100 | 1 | ≤0.4 um | 0.791 | 10.3 | 1379 | 81.1% |
| Embodiment 9 | 1100 | 12 | ≤1.3 um | 0.353 | 23 | 1285 | 82.1% |

It can be seen from the data in Table 3, as the reaction time increases, the thickness of the shell gradually increases, and the first coulombic efficiency also gradually increases. However, as the high-temperature treatment time is prolonged, the thickness of the shell will not increase significantly, and the Si grain size in the anode material will increase continuously, which will cause decreasing, rather than increasing, of the first coulombic efficiency of the anode material.

References to “some embodiments”, “part of embodiments”, “one embodiment”, “another example”, “example”, “specific example” or “part of examples” in the whole specification mean that at least one embodiment or example in the present application comprises specific features, structures, materials or characteristics described in the embodiments or examples. Thus, the descriptions that appear throughout the specification, such as “in some embodiments”, “in an embodiment”, “in one embodiment”, “in another example”, “in one example”, “in a specific example” or “an example”, do not necessarily refer to the same embodiment or example in the present application. Furthermore, the specific features, structures, materials or characteristics in the descriptions can be combined in any suitable manner in one or more embodiments or examples.

Although the illustrative embodiments have been shown and described, it should be understood by those skilled in the art that the above embodiments cannot be interpreted as limiting the present application, and the embodiments can be changed, substituted and modified without departing from the spirit, principle and scope of the present application.

What is claimed is:

1. An anode material, comprising:
a silicon oxide core, the silicon oxide being represented by the general formula SiOₓ (about 0<x<about 2); and
a shell, disposed on at least a portion of an outer surface of the silicon oxide core,
wherein the shell comprises a silicate of M, and
wherein M is selected from the group consisting of Mg, Ca, Sr, Ba, Al, Ti, Zn and a combination thereof.

2. The anode material according to claim 1, wherein the molar ratio of the M to the Si in the anode material is about 0.1 to about 0.6.

3. The anode material according to claim 1, wherein the thickness L of the shell is about L≤3.0 μm.

4. The anode material according to claim 1, wherein the content of M is gradually decreased from the outside of the shell to the inside of the shell.

5. The anode material according to claim 1, wherein the anode material comprises silicon grains, wherein the size D of the silicon grains is about 2 nm≤D≤about 40 nm, and wherein the size D is determined by the Scherrer equation based on the half-peak width of the diffraction peak of Si(111) in an X-ray diffraction analysis.

6. An anode, comprising an anode current collector and an anode active material layer, wherein the anode active material layer is located on at least one surface of the current collector, and wherein the anode active material layer comprises an anode material comprising:
a silicon oxide core, the silicon oxide being represented by the general formula SiOₓ (0<x<2); and
a shell, disposed on at least a portion of an outer surface of the silicon oxide core,
wherein the shell comprises a silicate of M, and
wherein M is selected from the group consisting of Mg, Ca, Sr, Ba, Al, Ti, Zn and a combination thereof.

7. The anode according to claim 6, wherein the molar ratio of the M to the Si in the anode material is about 0.1 to about 0.6.

8. The anode according to claim 6, wherein the thickness L of the shell is about L≤3.0 μm.

9. The anode according to claim 6, wherein the content of M is gradually decreased from the outside of the shell to the inside of the shell.

10. The anode according to claim 6, wherein the anode material comprises silicon grains, wherein the size D of the silicon grains is about 2 nm≤D≤about 40 nm, and wherein the size D is determined by the Scherrer equation based on the half-peak width of the diffraction peak of Si(111) in an X-ray diffraction analysis.

11. An electrochemical device, comprising a cathode, a separator, an electrolyte and an anode,
wherein the anode comprises an anode current collector and an anode active material layer, wherein the anode active material layer is located on at least one surface of the current collector, and wherein the anode active material layer comprises an anode material comprising:
a silicon oxide core, the silicon oxide being represented by the general formula SiOₓ (about 0<x<about 2); and
a shell, disposed on at least a portion of an outer surface of the silicon oxide core,
wherein the shell comprises a silicate of M, and
wherein M is selected from the group consisting of Mg, Ca, Sr, Ba, Al, Ti, Zn and a combination thereof.

12. The electrochemical device according to claim 11, wherein the molar ratio of the M to the Si in the anode material is about 0.1 to about 0.6.

13. The electrochemical device according to claim 11, wherein the thickness L of the shell is about L≤3.0 μm.

14. The electrochemical device according to claim 11, wherein the content of M is gradually decreased from the outside of the shell to the inside of the shell.

15. The electrochemical device according to claim 11, wherein the anode material comprises silicon grains, wherein the size D of the silicon grains is about 2 nm≤D≤about 40 nm, and wherein the size D is determined by the Scherrer equation based on the half-peak width of the diffraction peak of Si(111) in an X-ray diffraction analysis.

16. The electrochemical device according to claim 11, wherein the electrochemical device is a lithium-ion battery.

17. An electronic device, comprising an electrochemical device, comprising a cathode, a separator, an electrolyte and an anode,
wherein the anode comprises an anode current collector and an anode active material layer, wherein the anode active material layer is located on at least one surface of the current collector, and wherein the anode active material layer comprises an anode material comprising:
a silicon oxide core, the silicon oxide being represented by the general formula SiOₓ (about 0<x<about 2); and
a shell, disposed on at least a portion of an outer surface of the silicon oxide core,
wherein the shell comprises a silicate of M, and
wherein M is selected from the group consisting of Mg, Ca, Sr, Ba, Al, Ti, Zn and a combination thereof.

18. The electronic device according to claim 17, wherein the molar ratio of the M to the Si in the anode material is about 0.1 to about 0.6, the thickness L of the shell is about L≤3.0 μm, and the content of M is gradually decreased from the outside of the shell to the inside of the shell.

19. The electronic device according to claim 17, wherein the anode material comprises silicon grains, wherein the size D of the silicon grains is about 2 nm≤D≤about 40 nm, and wherein the size D is determined by the Scherrer equation based on the half-peak width of the diffraction peak of Si(111) in an X-ray diffraction analysis.

20. A method for preparing an anode material comprising a silicon oxide core and a shell disposed on at least a portion of an outer surface of the silicon oxide core, wherein the silicon oxide is represented by the general formula SiOₓ (0<x<2), and the shell comprises a silicate of M, and M is selected from the group consisting of Mg, Ca, Sr, Ba, Al, Ti, Zn and a combination thereof,
the method comprising:
mixing an M source and a silicon oxide;
carrying out a high-temperature treatment on the mixed material in an inert gas atmosphere at about 1000° C. to about 1400° C.; and
grinding the material subjected to the high-temperature treatment.
